(19) United States
(12) Patent Application Publication
(10) Pub. No.: US 2010/0038609 A1
(43) Pub. Date: Feb. 18, 2010

(54) HAMMERHEAD WITH LATERAL NAIL-PULLING GROOVE

(76) Inventor: Yung-Shou Chen, Taichung Hsien (TW)

Correspondence Address: PAI PATENT & TRADEMARK LAW FIRM, 1001 FOURTH AVENUE, SUITE 3200, SEATTLE, WA, 98154, US

(21) Appl. No.: 12/193,653

(22) Filed: Aug. 18, 2008

(51) Int. Cl. B25D 1/04

(52) U.S. Cl. 254/26 R

(57) ABSTRACT

A hammerhead having a claw, two cheeks and a V-groove at each of two opposite lateral sides of the claw for pulling nails sideways and a side gap between each of the two cheeks and the claw for receiving the head of the nail to be pulled sideways with the V-groove.

### BACKGROUND OF THE INVENTION

(a) Field of the Invention

The present invention relates to hammers and, more particularly, to a hammerhead that has a V-groove at each of two opposite lateral sides of the claw of the hammerhead for pulling nails sideways.

(b) Description of the Prior Art

A claw hammer generally comprises a handle and a metal hammerhead having a claw at the front side and a bell at the rear side. The claw has a V-groove for pulling nails in the forward direction. However, a hammer may be used in environments in which it is difficult to maneuver the hammer. For pulling nails in a narrow space or corner area, the claw may be not smoothly attachable to the nails to be pulled. In that case, it is difficult to pull the nails with a conventional claw hammer.

### SUMMARY OF THE INVENTION

The present invention has been accomplished under the circumstances in view. It is one object of the present invention to provide a hammer with a specifically designed hammerhead, which is convenient for use to pull nails in different environments, free from space and angle limitations.

According to one aspect of the present invention, the hammerhead comprises a claw, two cheeks, and a V-groove transversely disposed at one or each of the two opposite lateral sides of the claw for pulling nails sideways.

According to another aspect of the present invention, the hammerhead further comprises a side gap at one or each of the two opposite lateral sides thereof between the claw and the two cheeks. When pulling a nail with one V-groove, the head of the nail to be pulled is received in the associating side gap. When the user turned the hammer sideways to pull the nail out of the wood, the nail is kept in the V-groove and will not jump away, avoiding accidental injury.

### BRIEF DESCRIPTION OF THE DRAWINGS

FIG. 1 is an elevational view of a hammer in accordance with the present invention.

FIG. 2 is a front view of the hammerhead of the hammer in accordance with the present invention.

FIG. 3 is a schematic drawing showing one V-groove of the claw of the hammerhead attached to a nail according to the present invention.

FIG. 4 is a schematic drawing showing an application example of the present invention before a nail is attached to a V-groove of the claw.

FIG. 5 is a schematic drawing showing an application example of the present invention when a nail is attached to a V-groove of the claw.

### DETAILED DESCRIPTION OF THE PREFERRED EMBODIMENTS

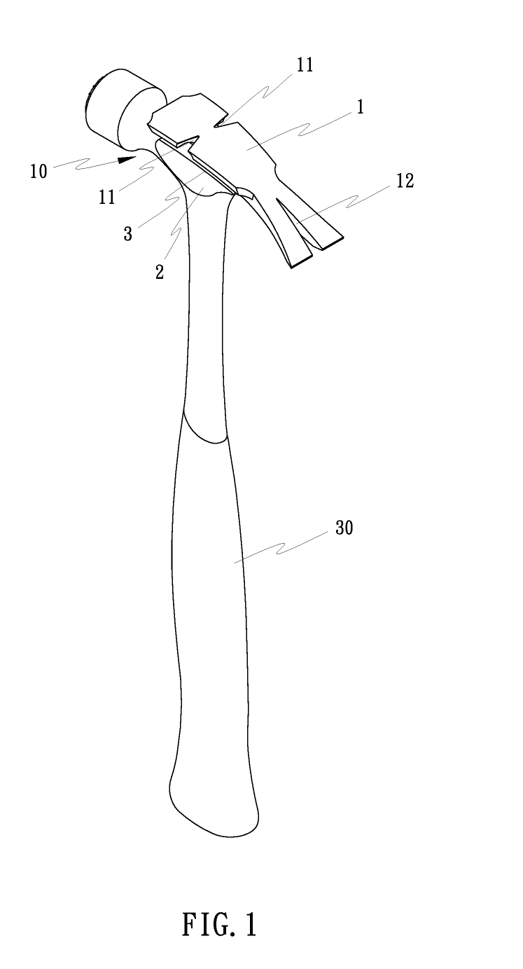

As shown in FIG. 1, a hammer with lateral nail-pulling function in accordance with the present invention comprises a handle 30 and a hammerhead 10 at one end of the handle 30. The hammerhead 10 comprises a claw 1, two cheeks 2 at two opposite lateral sides, and a side gap 3 at each of the two opposite lateral sides between the claw 1 and the cheeks 2. The claw 1 has a V-groove 11 transversely disposed at each of the two opposite lateral sides thereof for pulling nails sideways.

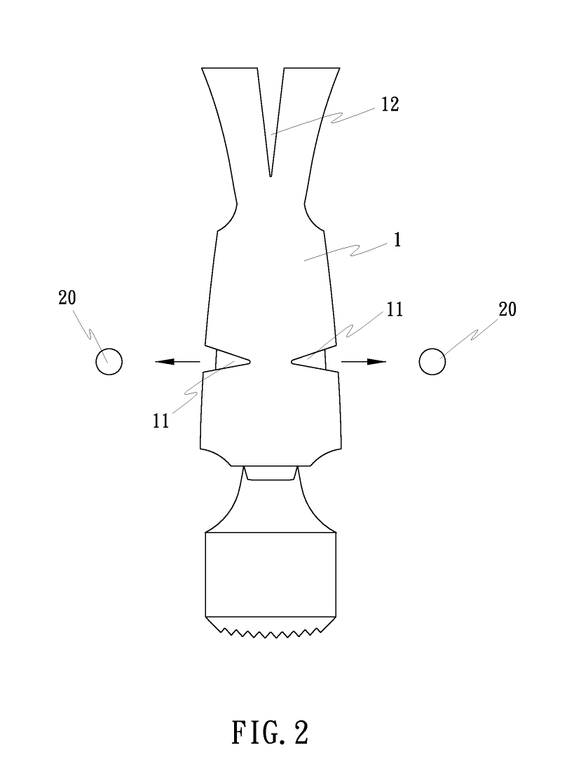

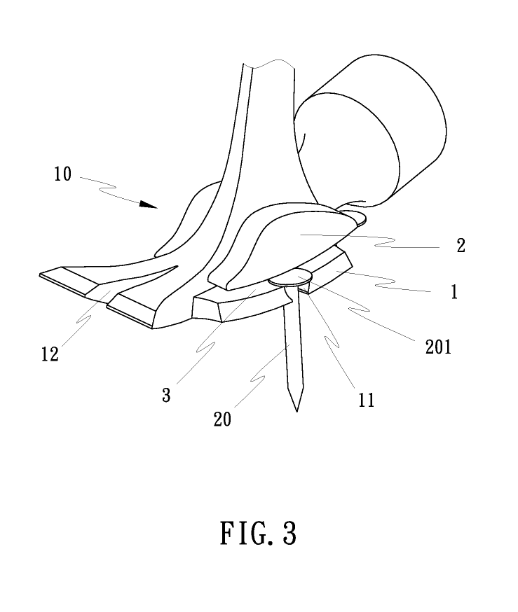

Referring to FIGS. 2 and 3 and FIG. 1 again, by means of the side gap 3 at each of the two opposite lateral sides between the claw 1 and the cheeks 2, one V-groove 11 of the claw 1 can be attached to a nail 20 in the wood to receive the head 201 of the nail 20 in the corresponding side gap 3 so that the hammer can be turned sideways to pull the nail 20 out of the wood.

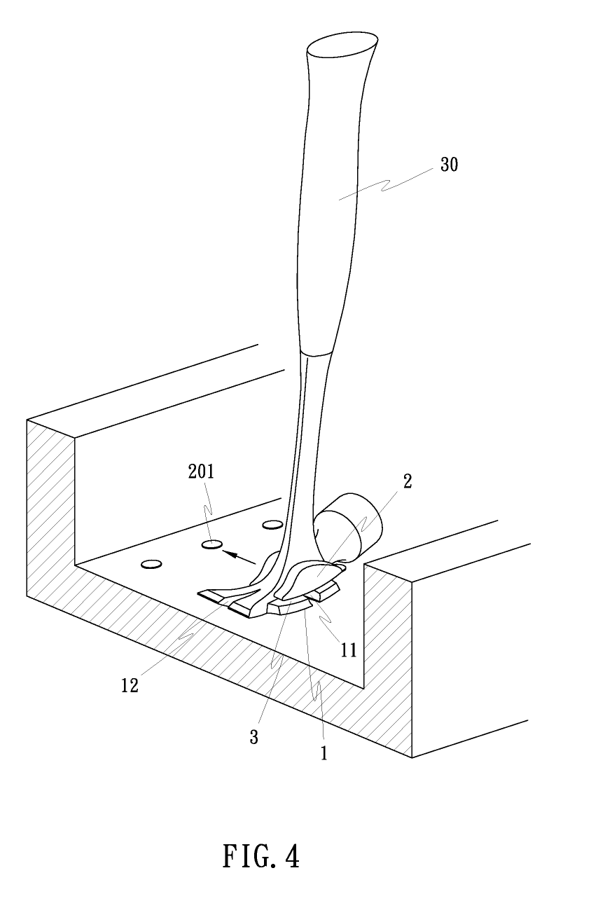

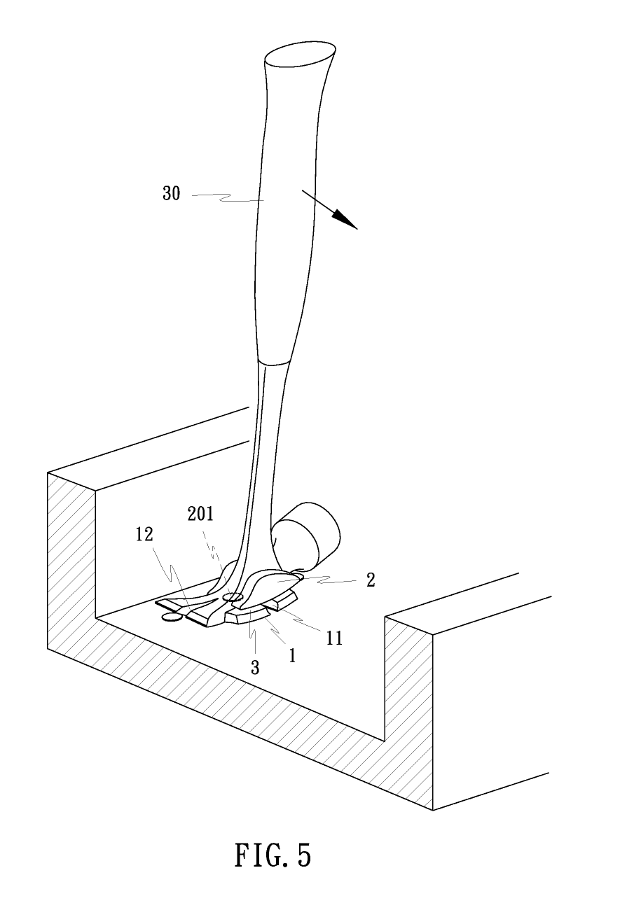

Referring to FIGS. 4 and 5, one V-groove 11 of the claw 1 can be attached to a nail 20 in a narrow space or near a side corner, and then the user can turn the handle 30 sideways (see the arrowhead sign shown in FIG. 5) to pull the nail 20 out of the wood easily. When the nail 20 is pulled out of the wood, the nail 20 is kept in the V-groove 11 and will not jump away, thus avoiding accidental injury.

Like the claw of a conventional claw hammer, the claw 1 has a front nail-pulling groove 12 for pulling nails in a forward direction. Further, the hammerhead 10 can be of any of a variety of claw hammer designs. Further, the invention can also be employed to a brick hammer, i.e., a brick hammer in accordance with the present invention has at least one V-groove 11 and one side gap 3 in it for pulling nails sideways.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A hammerhead comprising a claw, two cheeks, and at least one V-groove transversely disposed at at least one of two opposite lateral sides of the claw for pulling nails sideways.

2. The hammerhead as claimed in claim 1, further comprising at least one side gap between said claw and either of the two cheeks.
